(19) United States
(12) Patent Application Publication
(10) Pub. No.: US 2011/0277373 A1
(43) Pub. Date: Nov. 17, 2011

(54) BURROWING RODENT EXTERMINATION DEVICE

(76) Inventor: Donald D. Robbins, Caldwell, ID (US)

(21) Appl. No.: 12/780,451

(22) Filed: May 14, 2010

(51) Int. Cl. A01M 13/00

(52) U.S. Cl. 43/125; 43/124

(57) ABSTRACT

An extermination device for burrowing rodents that includes an internal combustion engine having an exhaust and a blower assembly, the exhaust of the internal combustion engine being diverted through the blower assembly, a pressurized flow of exhaust gas being directed through the outlet of the blower assembly. The outlet of the blower assembly is adapted for insertion into the opening of a burrow. In one embodiment the device is configured as a portable apparatus. In this embodiment, a common portable leaf blower may be modified so that the exhaust is bypassed through the blower assembly, to be forced by the blower assembly through its outlet. In another embodiment, the extermination device for burrowing rodents includes a blower assembly that is mountable on a vehicle, the internal combustion engine of the vehicle attachable to the blower assembly.

### BACKGROUND OF THE INVENTION

1. Field of the Invention

The present invention relates to a rodent control device and more particularly to a rodent extermination device for dispatching burrowing rodents employing a pressurized exhaust flow from an internal combustion engine.

2. Background

It is a well observed fact that burrowing rodents destroy food crops and compete with managed livestock for available forage. Burrowing rodents have also proven problematic for the homeowner, gardener and golf courses manager. Tunneling by burrowing rodents has also been known to weaken and collapse ditch banks, canals, irrigation systems and other waterworks and undermine foundations and roadways. It is also a well observed and documented fact that burrowing rodents are responsible annually for substantial crop loss. Various studies have estimated annual losses at anywhere from 5%-90% depending on the crop and the location of the planting.

As such numerous attempts have been made to combat burrowing rodents and to eliminate or at least reduce the damage attributable to these pests. U.S. Pat. No. 1,727,457 discloses a method for introducing gas from a manufactured cartridge into a tunnel for exterminating a burrowing animal. U.S. Pat. Nos. 4,026,330, 4,829,706, 5,588,252, 5,700,039 and 7,617,630 each disclose devices that are attached to an internal combustion engine to receive and transmit exhaust gas from the engine to a burrow to asphyxiate rodents inhabiting the burrow.

Similarly, U.S. Pat. 1,492,732 discloses a rodent extermination device and method that includes attaching a first end of a hose to an exhaust of an internal combustion engine and inserting a second end of the hose into a rodent burrow. A tank containing a poisonous gas it attached along the length of the hose. As exhaust from the engine passed through the hose, poisonous gas is drawn from the tank and mixed with the exhaust for introduction into the tunnel.

U.S. Pat. No. 7,581,349 discloses a method and apparatus for controlling rodents that collects exhaust gases from an internal combustion engine and then compresses the gas, holds the pressurized gas in a storage tank and injects the same under pressure into the underground burrows of rodents.

With devices such as those disclosed in U.S. Pat. Nos. 4,026,330, 4,829,706, 5,588,252, 5,700,039 and 7,617,630 it has been observed that inadequate pressure is developed simply by the flow of the exhaust from an internal combustion engine to reach the depths and lengths of burrows excavated by rodents. As such these devices are proven to be largely ineffective. While devices similar to that disclosed in U.S. Pat. No. 7,581,349 appear to have been successfully commercialized, these are not without their limitations. In particular an assembly that includes the three primary components of the disclosed device, an internal combustion engine, a compressor and a storage tank, all substantial in weight, is apt to be limited in portability. Additionally, the cost associated with the manufacture of the two pressure vessels required by the device would tend to result in a relatively expensive device.

A need exists to provide a relatively low cost alternative to the solution that includes a compressor and storage tank. Additionally, a need exists to provide a device with increased portability.

Therefore an object of the present invention is to provide an extermination device for burrowing rodents having a relatively lower cost of manufacture while still providing the advantage of a forced airflow. Another object of the present invention is to provide an extermination device for burrowing rodents that at least in one embodiment provides for increased portability over current solutions while still providing the advantage of a forced airflow.

### SUMMARY OF THE INVENTION

The present invention is directed to an extermination device for burrowing rodents that includes an internal combustion engine having an exhaust, the exhaust fluidly communicating with a blower, the blower adapted for fluid communication with a burrow.

In one embodiment, the extermination device for burrowing rodents includes a small displacement internal combustion engine having an attached blower assembly. The exhaust of the internal combustion engine is adapted so as to fluidly communicate with the blower assembly. In this embodiment the extermination device is configured as a hand-held portable device that may be manually transported from one burrow to the next. In this embodiment, a common portable leaf blower is modified so that the exhaust is bypassed through the blower assembly, to be forced by the blower assembly through its outlet.

In another embodiment, the extermination device for burrowing rodents includes a blower assembly that is mountable on a transport vehicle that may be used to transport the blower assembly to a burrow. Once the blower assembly has been transported to the location of a burrow, the internal combustion engine of the transport vehicle is attached to the blower assembly. The output of the blower assembly is then directed into the burrow. In this embodiment, the blower or fans of the of blower assembly are powered by one or more electric motors that are powered by the vehicle battery. The blower assembly may include a variable speed selector switch or rheostat to control fan speed and output.

### DESCRIPTION OF THE DRAWINGS

FIG. 1 is a representative view of an extermination device for burrowing rodents according to the present invention.

FIG. 2 is a representative view of an extermination device for burrowing rodents according to the present invention.

FIG. 3 is a representative view of an extermination device for burrowing rodents according to the present invention.

### DETAILED DESCRIPTION

Referring to FIG. 1 rodent extermination device 10 is shown including internal combustion engine 11 having intake 12 and exhaust 14. Exhaust 14 is coupled to inlet 16 of blower assembly 20. Blower assembly 20 includes collector box 15 that receives a flow from exhaust 14. Blowers 22A and 22B provide positive pressure through collector box 15, providing a pressurized flow through outlet 17. Power for blowers 22A and 22B is provided by battery 25. Blowers 22A and 22B may be configured including variable speed motors that are switchable by switch 23 that may be configured as a selector switch or a rheostat.

Once burrow B is located and nozzle 19 is inserted into the tunnel opening. Nozzle 19 is attached to outlet 17 by hose 18. Pressurized exhaust gas PEG is forced into burrow B causing the demise of rodent R.

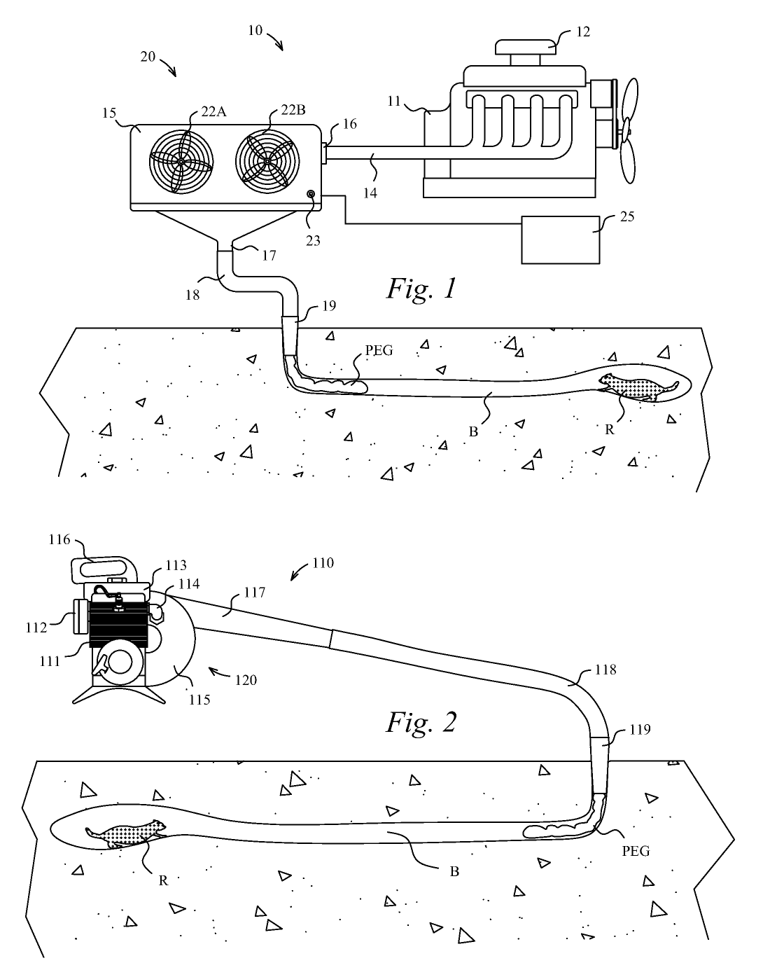

Referring to FIG. 2, an alternate embodiment of rodent extermination device 110 is shown. In this embodiment, rodent extermination device 110 is configured as a portable handheld device including internal combustion engine 111 having intake 112 and exhaust 114. Exhaust 114 is coupled to blower assembly 120. Blower assembly 120 includes housing 115 that receives a flow from exhaust 114. Blower assembly 120 provides positive pressure through outlet 117. Power for blower assembly 120 is provided by internal combustion engine 111.

Rodent extermination device 110 is transported to burrow B by carrying the device by handle 116. Nozzle 19 is inserted into the tunnel opening. Nozzle 119 is attached to outlet 117 by hose 118. Pressurized exhaust gas PEG is forced into burrow B causing the demise of rodent R.

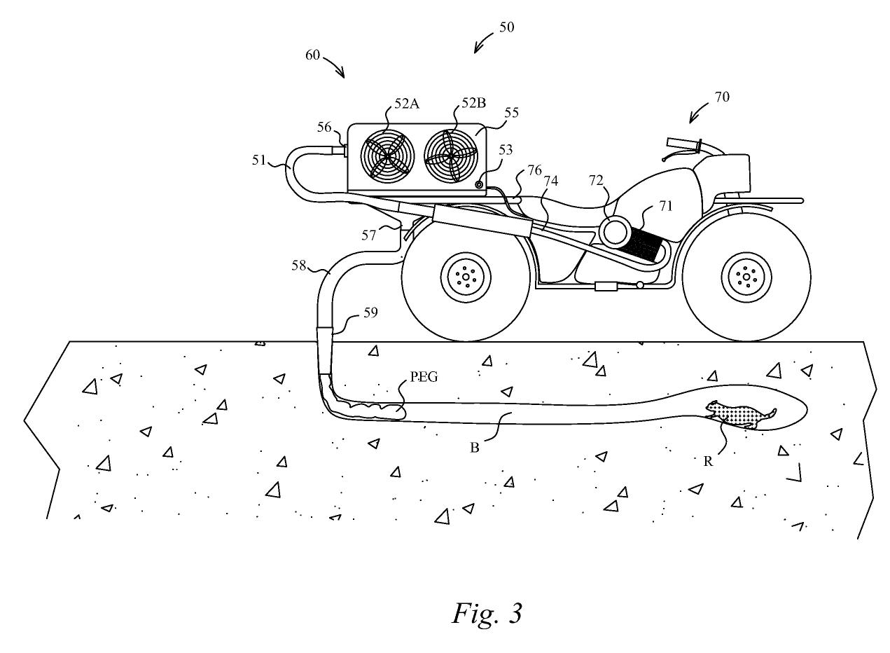

Referring to FIG. 3 rodent extermination device 50 is shown including internal combustion engine 71 which is also the engine for ATV 70. Internal combustion engine 71 includes intake 72 and exhaust 74. Blower assembly 50 is mounted to rear deck 76 of ATV 70. Exhaust 74 is coupled to inlet 56 of blower assembly 50. Blower assembly 50 includes collector box 55 that receives a flow from exhaust 74. Blowers 52A and 52B provide positive pressure through collector box 55, providing a pressurized flow through outlet 57. Power for blowers 52A and 52B is provided by a battery, (not shown), that serves as the battery for ATV 70. Blowers 52A and 52B may be configured including variable speed motors that are switchable by switch 53 that may be configured as a selector switch or a rheostat.

Once burrow B is located and nozzle 59 is inserted into the tunnel opening. Nozzle 59 is attached to outlet 57 by hose 58. Pressurized exhaust gas PEG is forced into burrow B causing the demise of rodent R.

The foregoing description of the illustrated embodiments has been presented for purposes of illustration and description. It is not intended to be exhaustive or to limit the invention to the precise form or to exemplary embodiment(s) and implementation(s) disclosed. Numerous modifications and variations will be apparent to practitioners skilled in this art. Elements described might be interchangeable with other elements in order to achieve the same result. At least one preferred embodiment was chosen and described in order to best explain the principles of the invention and a best mode of practical application, thereby to enable others skilled in the art to understand the invention for various embodiments and with various modifications as are suited to the particular use or implementation contemplated. It is intended that the scope of the invention be defined by the claims appended hereto and their equivalents. Reference to an element in the singular is not intended to mean “one and only one” unless explicitly so stated, but rather means “one or more.” Moreover, no element, component, nor method step in the present disclosure is intended to be dedicated to the public regardless of whether the element, component, or method step is explicitly recited in the following claims. No claim element herein is to be construed under the provisions of 35 U.S.C. Sec. 112, sixth paragraph unless the element is expressly recited using the phrase “means for . . .”

What is claimed is:

1. A rodent extermination device comprising:
an internal combustion engine having an exhaust; and
a blower assembly connected to the internal combustion engine, the blower assembly including an inlet, an outlet and a powered blower element for creating a positive pressure at the outlet, the exhaust of the internal combustion engine diverted through the blower assembly.

2. The rodent extermination device of claim 1 further comprising a battery connected to the blower assembly.

3. The rodent extermination device of claim 1 further comprising a flexible hose including a nozzle, the flexible hose adapted for attachment to the outlet of the blower assembly and the nozzle adapted for penetration of the burrow opening.

4. A rodent extermination device adapted for transport by a vehicle including an internal combustion engine having an exhaust, the rodent extermination device comprising a blower assembly connected to the exhaust of the internal combustion engine, the blower assembly including an inlet, an outlet and a powered blower element for creating a positive pressure at the outlet, the exhaust of the internal combustion engine diverted through the blower assembly.

5. The rodent extermination device of claim 4 further comprising a battery connected to the powered blower element.

6. The rodent extermination device of claim 4 further comprising a variable speed powered blower element.

7. The rodent extermination device of claim 4 further comprising a flexible hose including a nozzle, the flexible hose adapted for attachment to the outlet of the blower assembly and the nozzle adapted for penetration of the burrow opening.

8. The rodent extermination device of claim 4 further comprising a tubular segment adapted for attachment between the inlet of the blower assembly and the exhaust of the internal combustion engine.

9. A rodent extermination device comprising an internal combustion engine having an exhaust and a blower assembly connected to the internal combustion engine, the blower assembly having an inlet and an outlet and a blower element for creating a positive pressure at the outlet, the exhaust of the internal combustion engine diverted through the blower assembly, the blower element powered by the internal combustion engine.

10. The rodent extermination device of claim 9 further comprising a flexible hose including a nozzle, the flexible hose adapted for attachment to the outlet of the blower assembly and the nozzle adapted for penetration of the burrow opening.

11. The rodent extermination device of claim 9 further comprising a tubular segment adapted for attachment between the inlet of the blower assembly and the exhaust of the internal combustion engine.

12. The rodent extermination device of claim 9 further comprising a variable speed powered blower element.
